(19) United States
(12) Patent Application Publication
(10) Pub. No.: US 2022/0247246 A1
(43) Pub. Date: Aug. 4, 2022

(54) Rotor for an Electric Machine

(71) Applicant: ZF Friedrichshafen AG, Friedrichshafen (DE)

(72) Inventors: Ulrich Kehr, Tettnang (DE); Joachim Zanker, Oggelshausen (DE)

(21) Appl. No.: 17/517,201

(22) Filed: Nov. 2, 2021

(30) Foreign Application Priority Data
Feb. 1, 2021 (DE) 10 2021 200 874.7

(51) Int. Cl. H02K 1/276; H02K 21/14

(52) U.S. Cl. CPC H02K 1/2766; H02K 21/14

(57) ABSTRACT

A rotor for an electric machine, such as an electric motor, includes a pack of stacked rotor laminations (60). A sheet metal section of the rotor laminations (60) has guide webs (61) and open intermediate spaces (62). Raised areas (63) at the one side of each rotor lamination (60) correspond to indentations at the opposite, other side and form connecting bodies that extend in the axial direction and form-lockingly engage into an adjacent rotor lamination. Radial thrust forces are transferred from one rotor lamination (80) onto the adjacent rotor lamination.

### CROSS-REFERENCE TO RELATED APPLICATION

The present application is related and has right of priority to German Patent Application No. 102021200874.7 filed in the German Patent Office on Feb. 1, 2021, which is incorporated by reference in its entirety for all purposes.

### FIELD OF THE INVENTION

The invention relates generally to a rotor for an electric machine having a pack of stacked, magnetically active rotor laminations, the sheet metal section of which has guide webs formed from metal, and open intermediate spaces. The guide webs guide the magnetic flux, whereas the open intermediate spaces act as a flux barrier for the magnetic field lines.

The invention further relates generally to an electric machine having this type of rotor. An electric machine of this type functions, in particular, as an electric motor, although, in principle, it can also be utilized equally well as a generator.

### BACKGROUND

The turning motion of an electric motor is based on the mutual attractive and repulsive forces of the magnetic fields in the stator and the rotor. Usually, the stator is situated on the outside and is mounted in a housing in a rotationally fixed manner. In an internal-rotor electric machine of this type, the stator usually holds a current-carrying winding, which generates a magnetic field. A magnetic field is also built up in the rotating rotor, either in the guide webs of the rotor laminations due to the excitation by the stator currents and/or by permanent magnets buried in the open intermediate spaces.

In the geometric configuration of the sheet contour of the rotor laminations, there is a trade-off, at times, between the magnetic function and the mechanical function. The sheet metal section must form one contiguous area, so that the rotor lamination does not fall apart. Simultaneously, the guide webs formed from metal are to be as narrow as possible and the open intermediate spaces are to be as large as possible, in order to keep the magnetic permeability low. The metal guide webs must be selected to be so large that the arising mechanical forces, in particular centrifugal forces, are absorbed, and so the rotor is not deformed or even damaged during fast rotation.

Specifically in permanently excited synchronous motors or magnet-free reluctance synchronous motors, the intermediate spaces acting as a flux barrier for the magnetic field lines are designed as slots, which extend essentially transversely to the direction of the useful magnetic flux. These slots cannot be designed to be arbitrarily large, however, in particular not too wide, since the sheet-metal webs remaining therebetween can no longer absorb the arising centrifugal forces otherwise. For this reason, the open intermediate spaces or slots are interrupted by narrow connecting webs, which connect the metal guide webs and, as a result, reinforce primarily in the radial direction. These connecting webs result, however, in an undesirable magnetic flux, which is precisely to be prevented by the open intermediate spaces or slots.

### SUMMARY OF THE INVENTION

Example aspects of the present invention provide a rotor having stacked, magnetically active rotor laminations, configured for preventing the magnetic short circuits in the rotor laminations to the greatest extent possible, while simultaneously ensuring the mechanical strength of the rotor structure, in particular the stability against centrifugal forces.

According to example embodiments, connecting elements are arranged between the individual rotor laminations for transferring radial thrust forces from one rotor lamination onto the adjacent rotor lamination. The connecting elements provided according to example aspects of the invention reinforce the individual rotor laminations, and so the centrifugal forces are not or at least not completely absorbed by the metal guide webs of an individual rotor lamination, but rather are distributed onto multiple rotor laminations situated next to one another. Since the connecting elements are arranged between the individual rotor laminations, the open intermediate spaces between the guide webs formed from metal can be designed to be more open and more ample; in particular, otherwise necessary connecting webs, which interrupt the open intermediate spaces, can be avoided. In this way, the mechanical strength of the rotor is significantly increased, without the need to accept additional magnetic short circuits, which would reduce the power of the machine.

In one preferred example embodiment, the connecting elements are designed as connecting bodies integrally formed with the rotor laminations, and corresponding receptacles, wherein the connecting bodies and receptacles extend in the axial direction, and wherein the connecting bodies of one rotor lamination form-lockingly engage into the receptacles of the adjacent rotor lamination. According to example aspects of the invention, the connecting bodies therefore extend perpendicular to the sheet-metal plane of the rotor laminations and, thereby, also perpendicular to the magnetic field lines in the rotor lamination.

In particular, the connecting elements can be designed as raised areas at the one side of the rotor laminations and corresponding indentations at the opposite, other sides of the rotor laminations, preferably as bead profiles crimped into the sheet metal. Such raised areas and indentations or bead profiles can be easily and economically manufactured in the stamping process. A minimal axial extension of the raised areas and indentations suffices for achieving an effective mutual support of the rotor laminations.

Specifically in the case of highly effective reluctance electric motors, the desire is to design the open intermediate spaces between the metal guide webs to be as long as possible and also as wide as possible. The risk of an insufficient mechanical strength of the rotor lamination increases as a result. An arrangement of the connecting elements in the proximity of the edges of the open intermediate spaces has proven particularly advantageous in order to resolve, to the greatest extent possible, the trade-off between the most effective flux barriers possible, on the one hand, and the mechanical strength of the rotor laminations, on the other hand.

The connecting elements according to example aspects of the invention even permit sheet metal sections having slot-shaped intermediate spaces that extend predominantly in the radial direction and terminate at the peripheral edge of the rotor lamination, and so the intermediate spaces or slots transition into the air gap between the rotor and the stator. Rotor laminations, in which the sheet metal is interrupted directly at the outer edge by intermediate spaces, would be able to absorb barely higher centrifugal forces without the axial connecting elements.

In one preferred example embodiment of the rotor according to example aspects of the invention, additional support plates having a sheet metal section without intermediate spaces are inserted between the magnetically active rotor laminations. These support plates are utilized for absorbing the radial thrust forces from the adjacent rotor laminations. The mechanical forces, in particular centrifugal forces, are transferred from the metallic sections of the rotor laminations via the connecting elements onto the support plates, and so the force flow is finally completed via the support plates. The support plates have receptacles for the connecting elements.

Preferably, the support plates are arranged at regular axial intervals between the magnetically active rotor laminations. The interposition of a support plate approximately after every tenth rotor lamination has proven advantageous.

Example aspects of the present invention also provide an electric machine, in particular an electric motor, including a stator, which is mounted in a housing in a rotationally fixed manner, and including a rotor, in which, according to example aspects of the invention, connecting elements are arranged between the individual rotor laminations for transferring radial thrust forces from one rotor lamination onto the adjacent rotor lamination. The connecting elements according to example aspects of the invention come into play particularly advantageously in a permanently excited electric motor, in which permanent magnets are fitted in the open intermediate spaces of the rotor laminations.

### BRIEF DESCRIPTION OF THE DRAWINGS

Exemplary embodiments of the invention are described in the following with reference to the attached figures, in which:

FIG. 1 shows an electric motor according to the prior art, from the front;

FIG. 2 shows a detail of the electric motor from FIG. 1, in a larger scale;

FIG. 3 shows a rotor lamination of a rotor according to example aspects of the invention, in sections, in a horizontal section;

FIG. 4 shows the rotor lamination from FIG. 3, in an offset cross-section according to the line A;

FIG. 5 shows a rotor lamination of a second rotor according to example aspects of the invention, in sections, in a horizontal section;

FIG. 6 shows a rotor lamination of a third rotor according example aspects of to the invention, in sections, in a horizontal section.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

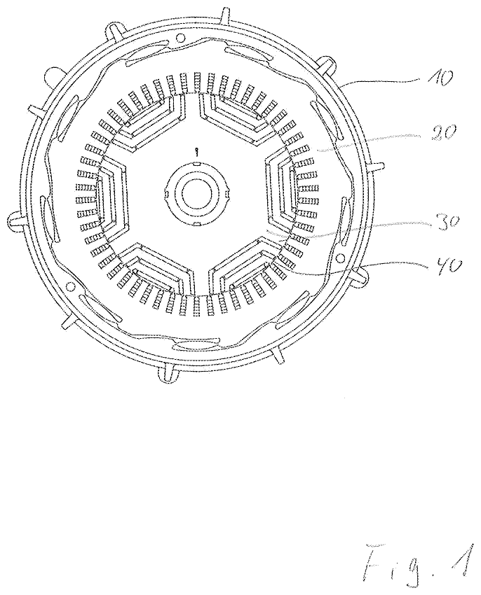

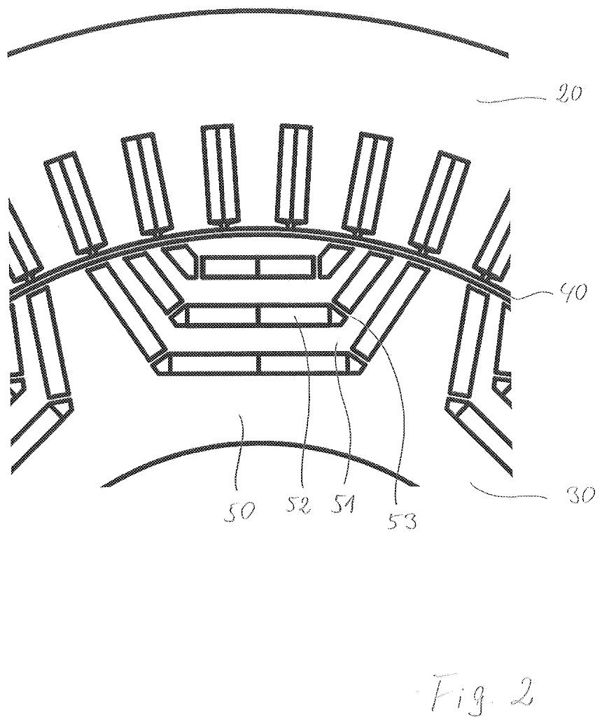

FIGS. 1 and 2 explain the prior art and its disadvantages.

The electric motor represented in FIG. 1 in a simplified manner has a cylindrical housing 10, in which a stator 20 is installed in a rotationally fixed manner. A concentrically arranged rotor 30 rotates in the interior of the stator 20. A small air gap 40 is present between the stator 20 and the rotor 30.

The enlarged representation in FIG. 2 shows a detail of the rotor 30. The rotor 30 consists of a pack of rotor laminations 50 stacked one on top of another. The sheet metal section of the rotor laminations 50 has guide webs 51 formed from magnetizable metal and open intermediate spaces 52 in the form of relatively narrow slots, which partly extend in the approximately radial direction and also approximately transversely to the radius. The intermediate spaces 52 are interrupted by thin connecting webs 53 formed from metal so that the rotor lamination 50 also does not fall apart in the area of the intermediate spaces and remains mechanically sufficiently stable.

The metal guide webs 51 guide the magnetic flux in the rotor lamination 50. The open intermediate spaces 52 act as a flux barrier for the magnetic field lines. The width of the connecting webs 53 is designed to be as small as possible in order to meet the requirement for minimal magnetic permeability. A certain minimum width of the connecting webs 53 cannot be fallen below, however, so that the arising mechanical forces, primarily the centrifugal forces acting in the radial direction, can also be absorbed in the area of the intermediate spaces 52 and, in particular, in the area of the peripheral edge of the rotor lamination 50. Nevertheless, an undesired magnetic flux arises due to the metallic connecting webs 53.

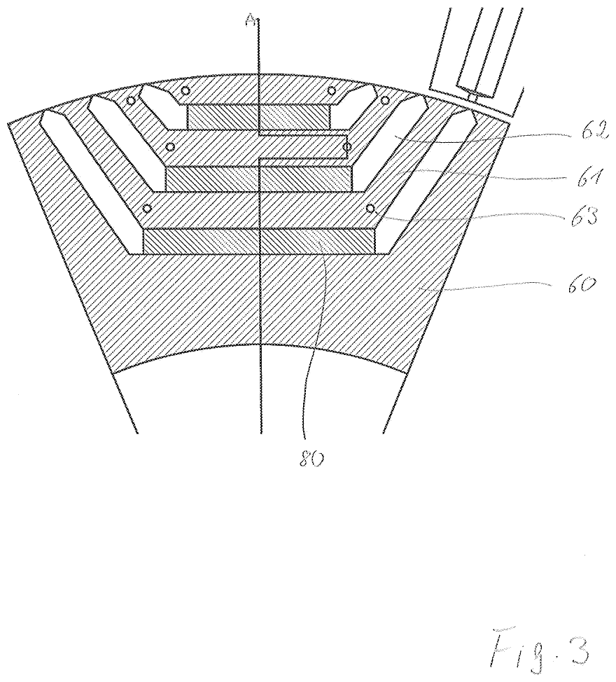

FIG. 3 shows a rotor lamination 60 of a rotor according to example aspects of the invention for an electric motor. This rotor lamination 60 also has a sheet metal section with guide webs 61 formed from metal, and open intermediate spaces 62, which are designed as relatively narrow slots. In contrast to the rotor lamination according to FIG. 2, the connecting webs utilized there, which interrupt the intermediate spaces, are missing. Instead, small round raised areas 63 are formed at the top side of the rotor lamination 60.

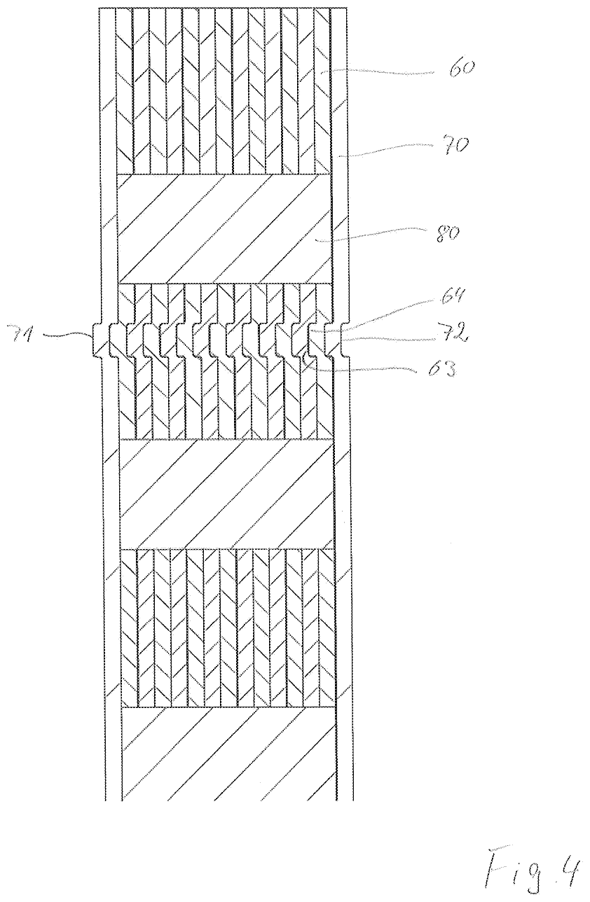

As is apparent from the associated offset cross-section in FIG. 4, particular corresponding indentations 64 are formed at the underside of the stacked rotor laminations 60. The raised areas 63 and the indentations 64 are formed by bead profiles 65 crimped into the sheet metal.

As is apparent from FIG. 4, support plates 70 without intermediate spaces are inserted between the magnetically active rotor laminations 60. One support plate 70 follows every ten rotor laminations 60 stacked one on top of another. The support plates 70 also have raised areas 71 and corresponding indentations 72 for the form-locking connection to the adjacent rotor lamination 60.

Permanent magnets 80 are fitted in the intermediate spaces 62 of the rotor laminations 60. The rotor in this case is the rotor of a permanently excited synchronous motor.

At a fast rotational speed of the electric motor, high centrifugal forces act, in particular, upon the peripheral sections of the rotor laminations 60. Due to the weakening of the sheet metal structure by the intermediate spaces 62, there is a risk that the relatively thin guide webs 61 bend radially outward under the effect of the centrifugal forces, which could result in a constriction of the air gap between the rotor and the stator (cf. FIG. 2). The connecting elements, in the form of the raised areas 63 and corresponding indentations 64, arranged between the individual rotor laminations 60 transfer the radial thrust forces from one rotor lamination 60 onto the adjacent rotor lamination. The bead profiles 65 (FIG. 4) replace the conventional connecting webs 53 (FIG. 2), as it were, and increase the strength of the rotor structure.

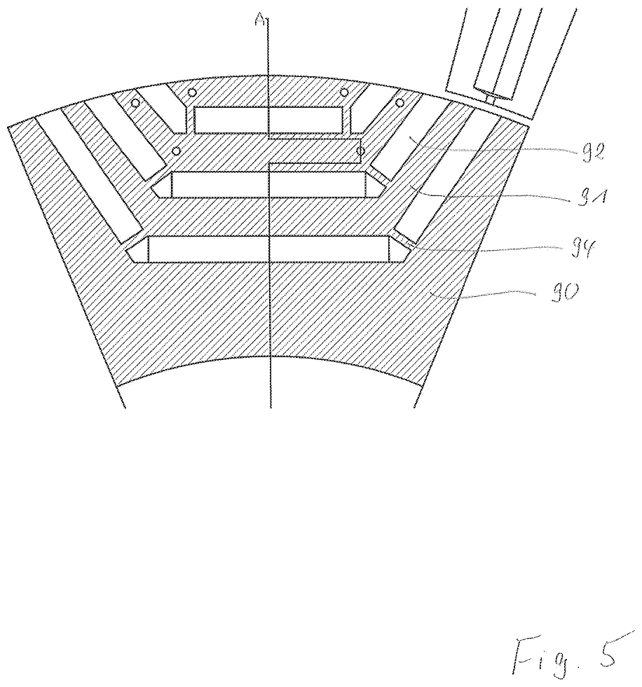

The rotor lamination 90 according to FIG. 5 essentially corresponds to the rotor lamination 60 according to FIGS. 3 and 4. The contours of the guide webs 91 and of the intermediate spaces 92 are slightly different in this case. The intermediate spaces 92 terminate in the air gap. Raised areas 93 at the one side of the rotor lamination 90, which form-lockingly engage into corresponding indentations of the adjacent rotor lamination, are arranged only in the area of the periphery of the rotor lamination 90. Therefore, there are narrow connecting webs 94 in this case, which interrupt the intermediate spaces 92.

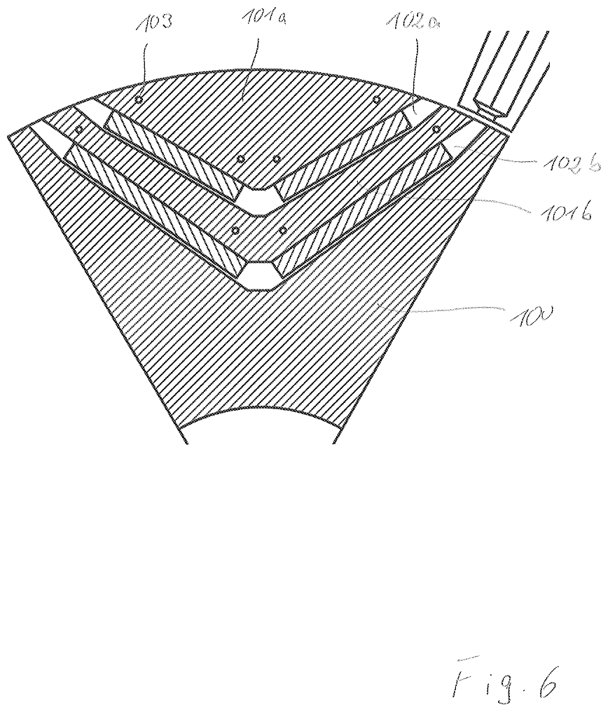

In the further example embodiment according to FIG. 6, the sheet metal section of the rotor lamination 100 has two guide webs 101a, 101b, which cut the sheet metal into three parts, and correspondingly designed intermediate spaces 102a, 102b, which are designed in the shape of slots and transition into the air gap between the rotor and the stator. In order to ensure that the rotor lamination 100 does not fall apart, multiple raised areas 103 are formed on the top side of the rotor lamination 100, which form-lockingly engage into corresponding indentations (not represented) at the opposite side of the particular adjacent rotor lamination.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. An element, a unit, an interface, a device, and a system can be partially or completely converted into hardware and/or into software. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 housing
20 stator
30 rotor
40 air gap
50 rotor lamination
51 guide web
52 intermediate space
53 connecting web
60 rotor lamination
61 guide web
62 intermediate space
63 raised area
64 indentation
65 bead profile
70 support plate
71 raised area
72 indentation
80 permanent magnet
90 rotor lamination
91 guide web
92 intermediate space
93 raised area
94 connecting web
100 rotor lamination
101a, 101b guide webs
102a, 102b intermediate spaces
103 raised area

1-13: (canceled)

14. A rotor for an electric machine, comprising:
a pack of stacked, magnetically active rotor laminations (60, 90, 100), a sheet metal section of each of the rotor laminations (60, 90, 100) has guide webs (61, 91, 101a, 101b) formed from metal and defines open intermediate spaces (62, 92, 102a, 102b), the guide webs are configured to guide magnetic flux, and the open intermediate spaces are configured to form a flux barrier for magnetic field lines,
wherein connecting elements are arranged between each adjacent pair of rotor laminations (60, 90, 100) for transferring radial thrust forces from one of the adjacent pair of rotor laminations onto the other of the adjacent pair of rotor laminations.

15. The rotor of claim 14, wherein:
the connecting elements comprise connecting bodies integrally formed with the rotor laminations (60, 90, 100) and corresponding receptacles, both of which extend in an axial direction; and
the connecting bodies of the one of the adjacent pair of rotor laminations form-lockingly engage into the receptacles of the other of the adjacent pair of rotor laminations.

16. The rotor of claim 14, wherein the connecting elements comprise raised areas (63) at one side of the rotor laminations (60) and corresponding indentations (64) at the opposite side of the rotor laminations.

17. The rotor of claim 14, wherein the connecting elements comprise bead profiles (65) crimped into the sheet metal section of each of the rotor laminations (60, 90, 100).

18. The rotor of claim 14, wherein the connecting elements are arranged proximate edges of the open intermediate spaces (62, 92, 102a, 102b).

19. The rotor of claim 14, wherein the open intermediate spaces (62, 92, 102a, 102b) comprise slots that extend predominantly in a radial direction.

20. The rotor of claim 19, wherein the slots terminate at a peripheral edge of the rotor laminations (90, 100) such that the slots transition into an air gap between the rotor and a stator.

21. The rotor of claim 14, further comprising a plurality of support plates (70) without intermediate spaces inserted between the rotor laminations (60, 90, 100), wherein the support plates (70) are configured for absorbing the radial thrust forces from adjacent rotor laminations.

22. The rotor of claim 21, wherein the support plates (70) are constructed of non-ferromagnetic material.

23. The rotor of claim 21, wherein the support plates (70) are arranged at regular axial intervals between the rotor laminations (60, 90, 100).

24. The rotor of claim 23, wherein a respective support plate (70) is interposed after every seventh to twelfth rotor lamination (60, 90, 100).

25. An electric machine, comprising:
a stator mounted in a housing in a rotationally fixed manner; and
the rotor of claim 14.

26. The electric machine of claim 25, further comprising permanent magnets (80) fitted in the open intermediate spaces (62, 102) of the rotor laminations (60, 100).
